(19) United States
(12) Patent Application Publication
(10) Pub. No.: US 2006/0090061 A1
(43) Pub. Date: Apr. 27, 2006

(54) Continual flow processor pipeline

(76) Inventors: Haitham Akkary, Portland, OR (US); Ravi Rajwar, Portland, OR (US); Srinivasan T. Srikanth, Portland, OR (US)

Correspondence Address: KENYON & KENYON LLP, 1500 K STREET N.W., SUITE 700, WASHINGTON, DC, 20005, US

(21) Appl. No.: 10/953,762

(22) Filed: Sep. 30, 2004

(51) Int. Cl. G06F 15/00

(52) U.S. Cl. 712/214

(57) ABSTRACT

Embodiments of the present invention relate to a system and method for comparatively increasing processor throughput and relieving pressure on the processor's scheduler and register file by diverting instructions dependent on long-latency operations from a flow of the processor pipeline and re-introducing them into the flow when the long-latency operations are completed. In this way, the instructions do not tie up resources and overall instruction throughput in the pipeline is comparatively increased.

### BACKGROUND

Microprocessors are increasingly being called on to support multiple cores on a single chip. To keep design efforts and costs down and to adapt to future applications, designers often try to design multiple core microprocessors that can meet the needs of an entire product range, from mobile laptops to high-end servers. This design goal presents a difficult dilemma to processor designers: maintaining the single-thread performance important for microprocessors in laptop and desktop computers while at the same time providing the system throughput important for microprocessors in servers. Traditionally, designers have tried to meet the goal of high single-thread performance using chips with single, large, complex cores. On the other hand, designers have tried to meet the goal of high system throughput by providing multiple, comparatively smaller, simpler cores on a single chip. Because, however, designers are faced with limitations on chip size and power consumption, providing both high single-thread performance and high system throughput on the same chip at the same time presents significant challenges. More specifically, a single chip will not accommodate many large cores, and small cores traditionally do not provide high single-thread performance.

One factor which strongly affects throughput is the need to execute instructions dependent on long-latency operations, such as the servicing of cache misses. Instructions in a processor may await execution in a logic structure known as a “scheduler.” In the scheduler, instructions with destination registers allocated wait for their source operands to become available, whereupon the instructions can leave the scheduler, execute and retire.

Like any structure in a processor, the scheduler is subject to area constraints and accordingly has a finite number of entries. Instructions dependent on the servicing of a cache miss may have to wait hundreds of cycles until the miss is serviced. While they wait, their scheduler entries are kept allocated and thus unavailable to other instructions. This situation creates pressure on the scheduler and can result in performance loss.

Similarly, pressure is created on the register file because the instructions waiting in the scheduler keep their destination registers allocated and therefore unavailable to other instructions. This situation can also be detrimental to performance, particularly in view of the fact that the register file may need to sustain thousands of instructions and is typically a power-hungry, cycle-critical, continuously clocked structure.

### BRIEF DESCRIPTION OF THE DRAWINGS

FIG. 1 shows elements of a processor comprising a slice processing unit according to embodiments of the present invention;

FIG. 2 shows a process flow according to embodiments of the present invention; and

FIG. 3 shows a system comprising a processor according to embodiments of the present invention.

### DETAILED DESCRIPTION

Embodiments of the present invention relate to a system and method for comparatively increasing processor throughput and memory latency tolerance, and relieving pressure on the scheduler and on the register file, by diverting instructions dependent on long-latency operations from a processor pipeline flow and re-introducing them into the flow when the long-latency operations are completed. In this way, the instructions do not tie up resources and overall instruction throughput in the pipeline is comparatively increased.

More specifically, embodiments of the present invention relate to identifying instructions dependent on long-latency operations, referred to herein as “slice” instructions, and moving them from the pipeline to a “slice data buffer” along with at least a portion of information needed for the slice instructions to execute. The scheduler entries and destination registers of the slice instructions may then be reclaimed for use by other instructions. Instructions independent of the long latency operations can use these resources and continue program execution. When the long-latency operations upon which the slice instructions in the slice data buffer depend are completed, the slice instructions may be re-introduced into the pipeline, executed and retired. Embodiments of the present invention thereby effect a non-blocking, continual flow processor pipeline.

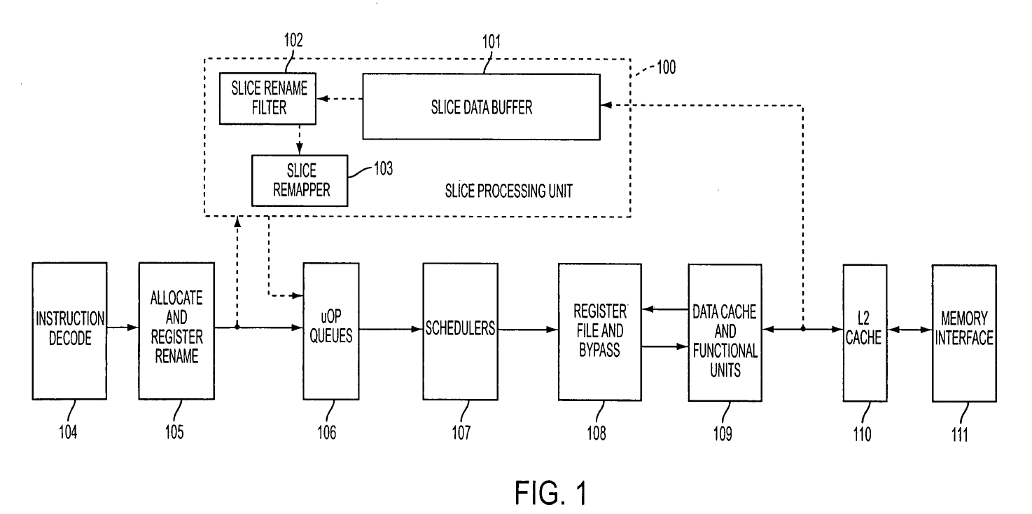

FIG. 1 shows an example of a system according to embodiments of the present invention. The system may comprise a “slice processing unit” 100 according to embodiments of the present invention. The slice processing unit 100 may comprise a slice data buffer 101, a slice rename filter 102, and a slice remapper 103. Operations associated with these elements are discussed in more detail further on.

The slice processing unit 100 may be associated with a processor pipeline. The pipeline may comprise an instruction decoder 104 to decode instructions, coupled to allocate and register rename logic 105. As is well known, processors may include logic such as allocate and register rename logic 105 to allocate physical registers to instructions and map logical registers of the instructions to the physical registers. “Map” as used here means to define or designate a correspondence between (in conceptual terms, a logical register identifier is “renamed” into a physical register identifier). More specifically, for the brief span of its life in a pipeline, an instruction's source and destination operands, when they are specified in terms of identifiers of the registers of the processor's set of logical (also “architectural”) registers, are assigned physical registers so that the instruction can actually be carried out in the processor. The physical register set is typically much more numerous than the logical register set and thus multiple different physical registers can be mapped to the same logical register.

The allocate and register rename logic 105 may be coupled to uop (“micro”-operation, i.e., instruction) queues 106 to queue instructions for execution, and the uop queues 106 may be coupled to schedulers 107 to schedule the instructions for execution. The mapping of logical registers to physical registers (referred to hereafter as “the physical register mapping”) performed by the allocate and register rename logic 105 may be recorded in a reorder buffer (ROB) (not shown) or in the schedulers 107 for instructions awaiting execution. According to embodiments of the present invention, the physical register mapping may be copied to the slice data buffer 101 for instructions identified as slice instructions, as described in more detail further on.

The schedulers 107 may be coupled to the register file, which includes the processor's physical registers, shown in FIG. 1 with bypass logic in block 108. The register file and bypass logic 108 may interface with data cache and functional units logic 109 that executes the instructions scheduled for execution. An L2 cache 110 may interface with the data cache and functional units logic 109 to provide data retrieved via a memory interface 111 from a memory subsystem (not shown).

As noted earlier, the servicing of a cache miss for a load that misses in the L2 cache may be considered a long-latency operation. Other examples of long latency operations include floating point operations and dependent chains of floating point operations. As instructions are processed by the pipeline, instructions dependent on long-latency operations may be classified as slice instructions and be given special handling according to embodiments of the present invention to prevent the slice instructions blocking or slowing pipeline throughput. A slice instruction may be an independent instruction, such as a load that generates a cache miss, or an instruction that depends on another slice instruction, such as an instruction that reads the register loaded by the load instruction.

When a slice instruction occurs in the pipeline, it may be stored in the slice data buffer 101, in its place in a scheduling order of instructions as determined by schedulers 107. A scheduler typically schedules instructions in data dependence order. The slice instruction may be stored in the slice data buffer with at least a portion of information necessary to execute the instruction. For example, the information may include the value of a source operand if available, and the instruction's physical register mapping. The physical register mapping preserves the data dependence information associated with the instruction. By storing any available source values and the physical register mapping with the slice instruction in the slice data buffer, the corresponding registers can be released and reclaimed for other instructions, even before the slice instruction completes. Further, when the slice instruction is subsequently re-introduced into the pipeline to complete its execution, it may be unnecessary to re-evaluate at least one of its source operands, while the physical register mapping ensures that the instruction is executed at the correct place in a slice instruction sequence.

According to embodiments of the present invention, identification of slice instructions may be performed dynamically by tracking register and memory dependencies of long-latency operations. More specifically, slice instructions may be identified by propagating a slice instruction indicator via physical registers and store queue entries. A store queue is a structure (not shown in FIG. 1) in the processor to hold store instructions queued for writing to memory. Load and store instructions may read or write, respectively, fields in store queue entries. The slice instruction indicator may be a bit, referred to herein as a “Not a Value” (NAV) bit, associated with each physical register and store queue entry. The bit may not be initially set (e.g., it has a value of logic “0”), but be set, (e.g. to logic “1”), when an associated instruction depends on long-latency operations.

The bit may initially be set for an independent slice instruction and then propagated to instructions directly or indirectly dependent on that independent instruction. More specifically, the NAV bit of the destination register of an independent slice instruction in the scheduler, such as a load that misses the cache, may be set. Subsequent instructions having that destination register as a source may “inherit” the NAV bit, in that the NAV bits in their respective destination registers may also be set. If the source operand of a store instruction has its NAV bit set, the NAV bit of the store queue entry corresponding to the store may be set. Subsequent load instructions either reading from or predicted to forward from that store queue entry may have the NAV bit set in their respective destinations. The instruction entries in the scheduler may also be provided with NAV bits for their source and destination operands corresponding to the NAV bits in the physical register file and store queue entries. The NAV bits in the scheduler entries may be set as corresponding NAV bits in the physical registers and store queue entries are set, to identify the scheduler entries as containing slice instructions. A dependency chain of slice instructions may be formed in the scheduler by the foregoing process.

In the normal course of operations in a pipeline, an instruction may leave the scheduler and be executed when its source registers are ready, that is, contain the values needed for the instruction to execute and yield a valid result. A source register may become ready when, for example, a source instruction has executed and written a value to the register. Such a register is referred to herein as a “completed source register.” According to embodiments of the present invention, a source register may be considered ready either when it is a completed source register, or when its NAV bit is set. Thus, a slice instruction can leave the scheduler when any of its source registers is a completed source register, and any source register that is not a completed source register has its NAV bit set. Slice instructions and non-slice instructions can therefore “drain” out of the pipeline in a continual flow, without the delays caused by dependence on long-latency operations, and allowing subsequent instructions to acquire scheduler entries.

Operations performed when a slice instruction leaves the scheduler may include recording, along with the instruction itself, the value of any completed source register of the instruction in the slice data buffer, and marking any completed source register as read. This allows the completed source register to be reclaimed for use by other instructions. The instruction's physical register mapping may also be recorded in the slice data buffer. A plurality of slice instructions (a “slice”) may be recorded in the slice data buffer along with corresponding completed source register values and physical register mappings. In consideration of the foregoing, a slice may be viewed as a self-contained program that can be re-introduced into the pipeline, when the long-latency operations upon which it depends complete, and executed efficiently since the only external input needed for the slice to execute is the data from the load (assuming the long-latency operation is the servicing of a cache miss). Other inputs have been copied to the slice data buffer as the values of completed source registers, or are generated internally to the slice.

Further, as noted earlier, the destination registers of the slice instructions may be released for reclamation and use by other instructions, relieving pressure on the register file.

In embodiments, the slice data buffer may comprise a plurality of entries. Each entry may comprise a plurality of fields corresponding to each slice instruction, including a field for the slice instruction itself, a field for a completed source register value, and fields for the physical register mappings of source and destination registers of the slice instruction. Slice data buffer entries may be allocated as slice instructions leave the scheduler, and the slice instructions may be stored in the slice data buffer in the order they had in the scheduler, as noted earlier. The slice instructions may be returned to the pipeline, in due course, in the same order. For example, in embodiments the instructions could be reinserted into the pipeline via the uop queues 107, but other arrangements are possible. In embodiments, the slice data buffer may be a high density SRAM (static random access memory) implementing a long-latency, high bandwidth array, similar to an L2 cache.

Reference is now made again to FIG. 1. As shown in FIG. 1 and discussed earlier, a slice processing unit 100 according to embodiments of the present invention may comprise a slice rename filter 102 and a slice remapper 103. The slice remapper 103 may map new physical registers to the physical register identifiers of the physical register mappings in the slice data buffer, in a way analogous to the way the allocate and register rename logic 105 maps logical registers to physical registers. This operation may be needed because the registers of the original physical register mapping were released as described above. These registers will likely have been reclaimed and be in use by other instructions when a slice is ready to be re-introduced into the pipeline.

The slice rename filter 102 may be used for operations associated with checkpointing, a known process in speculative processors. Checkpointing may be performed to preserve the state of the architectural registers of a given thread at a given point, so that the state can be readily recovered if needed. For example, checkpointing may be performed at a low-confidence branch.

If a slice instruction writes to a checkpointed physical register, that instruction should not be assigned a new physical register by the remapper 103. Instead, that checkpointed physical register must be mapped to the same physical register originally assigned to it by the allocate and register rename logic 105, otherwise the checkpoint would become corrupted/invalid. The slice rename filter 102 provides the information to the slice remapper 103 as to which physical registers are checkpointed, so that the slice remapper 102 can assign their original mappings to the checkpointed physical registers. When the results of slice instructions that write to checkpointed registers are available, they may be merged or integrated with the results of independent instructions writing to checkpointed registers that completed earlier.

According to embodiments of the present invention, the slice remapper 103 may have available to it, for assigning to the physical register mappings of slice instructions, a greater number of physical registers than does the allocate and register rename logic 105. This may be in order to prevent deadlocks due to checkpointing. More specifically, physical registers may be unavailable to be remapped to slice instructions because the physical registers are tied up by checkpoints. On the other hand, it may be the case that only when the slice instructions complete can the physical registers tied up by the checkpoints be released. This situation can lead to deadlock.

Accordingly, as noted above, the slice remapper could have a range of physical registers available for mapping that is over and above the range available to the allocate and register rename logic 105. For example, there could be 192 actual physical registers in a processor; 128 of these might be made available to the allocate and register rename logic 105 for mapping to instructions, while the entire range of 192 would be available to the slice remapper. Thus, in this example, an extra 64 physical registers would be available to the slice remapper to ensure that a deadlock situation due to registers being unavailable in the base set of 128 does not occur.

An example will now be given, referring to elements of FIG. 1. Assume that each instruction in the sequence of instructions (1) and (2), below, has been allocated a corresponding scheduler entry in the schedulers 107. For conciseness, further assume that the register identifiers indicated represent the physical register mapping; i.e., they refer to physical registers allocated by the instructions, to which the logical registers of the instructions have been mapped. Thus, a corresponding logical register is implicit for each of the physical register identifiers.
(1) R1<--Mx
   (load the contents of the memory location whose address is Mx into physical register R1)
(2) R2<--R1+R3
   (add the contents of physical registers R1 and R3 and place the result in physical register R2)

In the schedulers 107, instructions (1) and (2) await execution. When their source operands become available, instructions (1) and (2) can leave the scheduler and execute, making their respective entries in the schedulers 107 available to other instructions. The source operand of load instruction (1) is a memory location, and thus instruction (1) requires the correct data from the memory location to be present in the L1 cache (not shown) or L2 cache 110. Instruction (2) depends on instruction (1) in that it needs instruction (1) to execute successfully in order for the correct data to be present in register R1. Assume that register R3 is a completed source register.

Now further assume the load instruction, instruction (1), misses in the L2 cache 110. Typically, it could take hundreds of cycles for the cache miss to be serviced. During that time, in a conventional processor the scheduler entries occupied by instructions (1) and (2) would be unavailable for other instructions, inhibiting throughput and lowering performance. Moreover, physical registers R1, R2 and R3 would remain allocated while the cache miss was serviced, creating pressure on the register file.

By contrast, according to embodiments of the present invention, instructions (1) and (2) may be diverted to the slice processing unit 100 and their corresponding scheduler and register file resources freed for use by other instructions in the pipeline. More specifically, the NAV bit may be set in R1 when instruction (1) misses the cache, and then, based on the fact that instruction (2) reads R1, also set in R2. Subsequent instructions, not illustrated, having R1 or R2 as sources, would also have the NAV bit set in their respective destination registers. The NAV bits in the scheduler entries corresponding to the instructions would also be set, identifying them as slice instructions.

Instruction (1) is, more particularly, an independent slice instruction because it does not have as a source a register or store queue entry. On the other hand, instruction (2) is a dependent slice instruction because it has as a source a register whose NAV bit is set.

Because the NAV bit is set in R1, instruction (1) can exit the schedulers 107. Pursuant to exiting the schedulers 107, instruction (1) is written into the slice data buffer 101, along with its physical register mapping R1 (to some logical register). Similarly, because the NAV bit is set in R1 and because R3 is a completed source register, instruction (2) can exit the schedulers 107, whereupon instruction (2), the value of R3, and the physical register mappings R1 (to some logical register), R2 (to some logical register) and R3 (to some logical register) are written into the slice data buffer 101. Instruction (2) follows instruction (1) in the slice data buffer, just as it did in the schedulers. The scheduler entries formerly occupied by instructions (1) and (2), and registers R1, R2 and R3 can all now be reclaimed and made available for use by other instructions.

When the cache miss generated by instruction (1) is serviced, instructions (1) and (2) may be inserted, in their original scheduling order, back into the pipeline, with a new physical register mapping performed by the slice remapper 103. The completed source register value may be carried with the instruction as an immediate operand. The instructions may subsequently be executed.

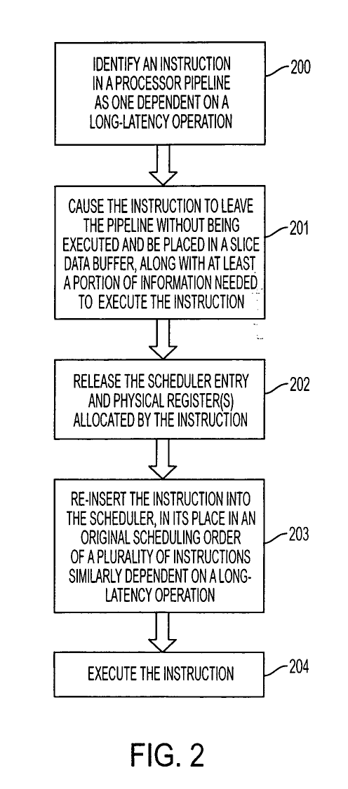

In view of the foregoing description, FIG. 2 shows process flow according to embodiments of the present invention. As shown in block 200, the process may comprise identifying an instruction in a processor pipeline as one dependent on a long-latency operation. For example, the instruction could be a load instruction that generates a cache miss.

As shown in block 201, based on the identification, the instruction may be caused to leave the pipeline without being executed and be placed in a slice data buffer, along with at least a portion of information needed to execute the instruction. The at least a portion of information may include a value of a source register and a physical register mapping. The scheduler entry and physical register(s) allocated by the instruction may be released and reclaimed for use by other instructions, as shown in block 202.

After the long-latency operations complete, the instruction may be re-inserted into the pipeline, as shown in block 203. The instruction may be one of a plurality of instructions moved from the pipeline to the slice data buffer, based on their being identified as instructions dependent on a long-latency operation. The plurality may be moved to the slice data buffer in a scheduling order, and re-inserted into the pipeline in that same order. The instruction may then be executed, as shown in block 204.

It is noted that to allow precise exception handling and branch recovery on a checkpoint processing and recovery architecture that implements a continual flow pipeline, two types of registers should not be released until the checkpoint is no longer required: registers belonging to the checkpoint's architectural state, and registers corresponding to the architectural “live-outs” Liveout registers, as is well known, are the logical registers and corresponding physical registers that reflect the current state of a program. More specifically, a liveout register corresponds to the last or most recent instruction of a program to write to a given logical register of a processor's logical instruction set. The liveout and checkpointed registers are, however, small in number (on the order of logical registers) as compared to the physical register file.

Other physical registers can be reclaimed when (1) all subsequent instructions reading the registers have read them, and (2) the physical registers have been subsequently re-mapped, i.e., overwritten. A continual flow pipeline according to embodiments of the present invention guarantees condition (1) because completed source registers are marked as read for slice instructions before the slice instructions even complete but after they read the value of the completed source registers. Condition (2) is met during normal processing itself—for L logical registers, the (L+1)^{th} instruction requiring a new physical register mapping will overwrite an earlier physical register mapping. Thus for every N instructions with a destination register leaving the pipeline, N−L physical registers will be overwritten and hence condition (2) will be satisfied.

Thus, by ensuring that values of completed source registers and physical register mapping information are recorded for a slice, registers can be reclaimed at such a rate that whenever an instruction requires a physical register, such a register is always available—hence achieving the continual flow property.

It is further noted that the slice data buffer can contain multiple slices due to multiple independent loads. As discussed earlier, the slices are essentially self-contained programs waiting only for load miss data values to return in order to be ready to execute. Once the load miss data values are available, the slices can be drained (re-inserted into the pipeline) in any order. Servicing of load misses may complete out of order, and thus, for example, a slice belonging to a later miss in the slice data buffer may be ready for re-insertion into the pipeline prior to an earlier slice in the slice data buffer. There are a plurality of options for handling this situation: (1) wait until the oldest slice is ready and drain the slice data buffer in a first-in, first-out order, (2) drain the slice data buffer in a first-in, first-out order when any miss in the slice data buffer returns, and (3) drain the slice data buffer sequentially from the miss serviced (may not necessarily result in draining the oldest slice first).

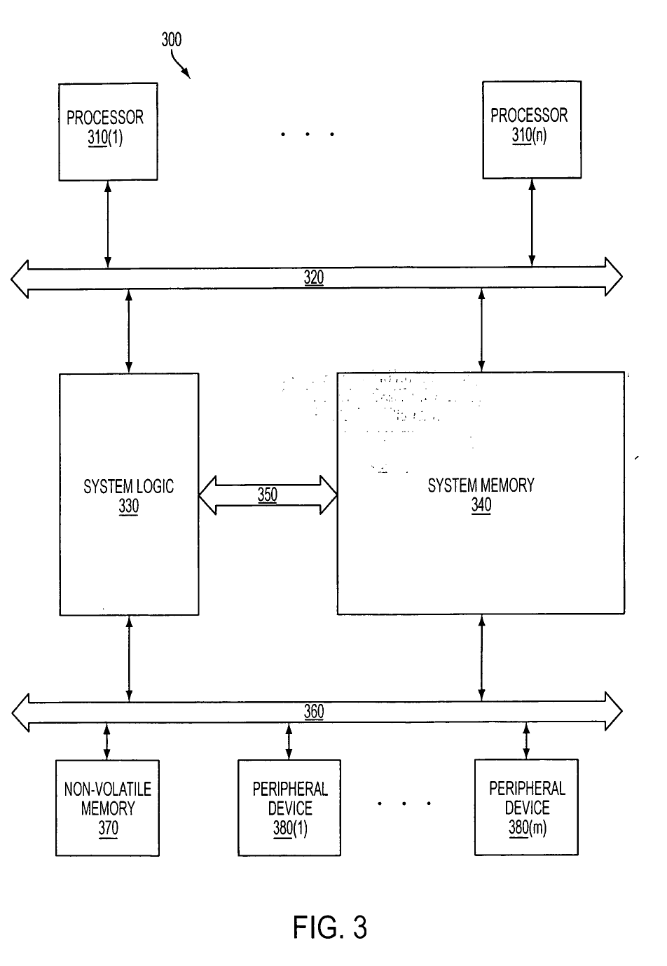

FIG. 3 is a block diagram of a computer system, which may include an architectural state, including one or more processor packages and memory for use in accordance with an embodiment of the present invention. In FIG. 3, a computer system 300 may include one or more processor packages 310(1)-310(n) coupled to a processor bus 320, which may be coupled to a system logic 330. Each of the one or more processor packages 310(1)-310(n) may be N-bit processor packages and may include a decoder (not shown) and one or more N-bit registers (not shown). System logic 330 may be coupled to a system memory 340 through a bus 350 and coupled to a non-volatile memory 370 and one or more peripheral devices 380(1)-380(m) through a peripheral bus 360. Peripheral bus 360 may represent, for example, one or more Peripheral Component Interconnect (PCI) buses, PCI Special Interest Group (SIG) PCI Local Bus Specification, Revision 2.2, published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripheral buses. Non-volatile memory 370 may be a static memory device such as a read only memory (ROM) or a flash memory. Peripheral devices 380(1)-380(m) may include, for example, a keyboard; a mouse or other pointing devices; mass storage devices such as hard disk drives, compact disc (CD) drives, optical disks, and digital video disc (DVD) drives; displays and the like.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
identifying an instruction in a processor pipeline as one dependent on a long-latency operation;
based on the identification, causing the instruction to be placed in a data storage area, along with at least a portion of information needed to execute the instruction; and
releasing a physical register allocated by the instruction.

2. The method of claim 1, further comprising releasing a scheduler entry occupied by the instruction.

3. The method of claim 1, further comprising:
after the long-latency operation completes, re-inserting the instruction into the pipeline.

4. The method of claim 1, wherein the at least a portion of the information includes a value of a source register of the instruction.

5. The method of claim 1, wherein the at least a portion of the information includes a physical register mapping of the instruction.

6. The method of claim 1, wherein the instruction is one of a plurality of instructions in the pipeline dependent on a long-latency operation, and the plurality of instructions is placed in the data storage area in a scheduling order of the instructions.

7. The method of claim 6, further comprising:
after the long-latency operation completes, re-inserting the plurality of instructions into the pipeline in the scheduling order.

8. A processor comprising:
a data storage area to store instructions identified as dependent on a long-latency operation, the data storage area comprising, for each instruction, a field for the instruction, a field for a value of a source register of the instruction, and a field for a physical register mapping of a register of the instruction.

9. The processor of claim 8, further comprising:
a remapper coupled to the data storage area to map physical registers to physical register identifiers of the physical register mappings of the data storage area.

10. The processor of claim 8, further comprising a filter to identify checkpointed physical registers for the remapper.

11. A system comprising:
a memory to store instructions; and
a processor coupled to the memory to execute the instructions, wherein the processor includes a data storage area to store instructions identified as dependent on a long-latency operation, the data storage area comprising, for each instruction, a field for the instruction, a field for a value of a source register of the instruction, and a field for a physical register mapping of a register of the instruction.

12. The system of claim 11, the processor further comprising:
a remapper coupled to the data storage area to map physical registers to physical register identifiers of the physical register mappings of the data storage area.

13. The system of claim 11, the processor further comprising a filter to identify checkpointed physical registers for the remapper.

14. A method comprising:
executing a load instruction that generates a cache miss;
setting an indicator in a destination register allocated to the load instruction to indicate that the load instruction depends on a long-latency operation;
moving the load instruction to a data storage area along with at least a portion of information needed to execute the load instruction; and
releasing the destination register allocated to the load instruction.

15. The method of claim 14, further comprising:
based on the indicator set in the destination register of the load instruction, setting an indicator in a destination register of another instruction;
moving the other instruction to the data storage area along with at least a portion of information needed to execute the other instruction; and
releasing a physical register allocated to the other instruction.

16. The method of claim 15, further comprising releasing scheduler entries allocated by the load instruction and the other instruction.

17. The method of claim 15, wherein the at least a portion of the information includes a physical register mapping of the other instruction.

18. The method of claim 15, further comprising:
after the long-latency operation completes, re-inserting the load instruction and the other instruction into a processor pipeline in a scheduling order.
